(19) United States
(12) Patent Application Publication
(10) Pub. No.: US 2026/0046009 A1
(43) Pub. Date: Feb. 12, 2026

(54) SIDELINK (SL) BEAM CONFIGURATION METHOD AND APPARATUS, DEVICE AND STORAGE MEDIUM

(71) Applicant: BEIJING XIAOMI MOBILE SOFTWARE CO., LTD., Beijing (CN)

(72) Inventor: Xing YANG, Beijing (CN)

(73) Assignee: BEIJING XIAOMI MOBILE SOFTWARE CO., LTD., Beijing (CN)

(21) Appl. No.: 19/100,801

(22) PCT Filed: Aug. 4, 2022
(86) PCT No.: PCT/CN2022/110389

§ 371 Date: Feb. 3, 2025

(51) Int. Cl. H04B 7/06

(52) U.S. Cl. CPC H04B 7/06954; H04B 7/06964

(57) ABSTRACT

The disclosure provides an SL beam configuration method, apparatus, device and storage medium. In one example, the SL beam configuration method includes: determining at least one SL beam configuration, the SL beam configuration including: first indication information indicating the SL beam, and a reference signal correspondingly carried by the SL beam; sending the at least one SL beam configuration to the second terminal device, and the first terminal device communicates with the second terminal device based on the SL; the SL beam is sent to the second terminal device based on the SL beam indicated in at least one SL beam configuration. The disclosed method provides a method for configuring the SL beam between the terminal devices directly connected to the SL, so that the SL transmission can support beam communication.

### CROSS-REFERENCE TO RELATED APPLICATION

The application is the U.S. National Stage of International Application No. PCT/CN2022/110389 filed on Aug. 4, 2022, the entire content of which is incorporated herein by reference for all purposes.

### TECHNICAL FIELD

The present disclosure relates to the field of communication technology, in particular to an SL beam configuration method, apparatus, device and storage medium.

### BACKGROUND

In communication system, direct communication between terminal devices is realized by introducing the sidelink (SL) communication mode. At the same time, in communication systems, communication between devices is usually based on beams to increase data transmission rates and reduce interference.

However, no specific beam communication process has been introduced for SL transmission at present, so SL transmission does not support beam communication currently.

### SUMMARY

The present disclosure provides a SL beam configuration method, apparatus, device and storage medium.

In the first aspect, the embodiments of this disclosure provide an SL beam configuration method, and this method is executed by a first terminal device, including:
determining at least one SL beam configuration, the SL beam configuration including: first indication information indicating the SL beam, and a reference signal corresponding to the SL beam;
sending the at least one SL beam configuration to a second terminal device, and the first terminal device communicating with the second terminal device based on the SL beam;
sending a reference signal to the second terminal device based on the SL beam indicated in the at least one SL beam configuration.

In the second aspect, the disclosed embodiment provides an SL beam configuration method that is performed by a second terminal device, including:
determining at least one SL beam configuration applicable to a first terminal device, wherein the first terminal device communicates with the second terminal device based on the SL, and the SL beam configuration including: first indication information indicating the SL beam, and a reference signal correspondingly carried by the SL beam;
receiving a reference signal transmitted by the first terminal device based on the at least one SL beam configuration.

In the third aspect, the disclosed embodiment provides an SL beam configuration method that is executed by a network device, including:
indicating at least one SL beam configuration to a first terminal device, the SL beam configuration including: first indication information indicating an SL beam, and a reference signal carried by the SL beam.

In the fourth aspect, the disclosed embodiment provides a communication apparatus configured in the first terminal device, including:
a processing module, configured to determine at least one SL beam configuration, the SL beam configuration including: first indication information indicating the SL beam, and, a reference signal carried by the SL beam;
a transceiver module, configured to send the at least one SL beam configuration to a second terminal device, and a first terminal device communicating with the second terminal device based on the SL;
the transceiver module, configured to send a corresponding reference signal to the second terminal device based on the SL beam indicated in the at least one SL beam configuration.

In the fifth aspect, the disclosed embodiment provides a communication apparatus configured in a second terminal device, including:
a processing module, configured to determine at least one SL beam configuration applicable to a first terminal device, wherein the first terminal device communicates with a second terminal device based on the SL, and the SL beam configuration includes: first indication information indicating the SL beam, and a reference signal carried by the SL beam;
a transceiver module, configured to receive a reference signal sent by the first terminal device based on the at least one SL beam configuration.

In the sixth aspect, the embodiment of the disclosure provides a communication apparatus configured in a network device, including:
a transceiver module, configured to indicate at least one SL beam configuration to a first terminal device, and the SL beam configuration including: first indication information indicating an SL beam, and a reference signal carried by the SL beam.

In the seventh aspect, the embodiment of the disclosure provides a communication apparatus that includes a processor that, when the processor invokes a computer program in memory, executes the method described in the first aspect above.

In the eighth aspect, the embodiment of the disclosure provides a communication device that includes a processor that, when the processor invokes a computer program in memory, executes the method described in the second aspect above.

In the ninth aspect, the disclosed embodiment provides a communication device including a processor that, when the processor invokes a computer program in memory, executes the method described in the third aspect above.

In the tenth aspect, the embodiment of the disclosure provides a communication device including a processor and a memory in which a computer program is stored; The processor executes a computer program stored in the memory so that the communication device performs the method described in the first aspect.

In the eleventh aspect, the embodiment of the disclosure provides a communication device including a processor and a memory in which a computer program is stored; the processor executes a computer program stored in the memory so that the communication device performs the method described in the second aspect above.

In the twelfth aspect, the embodiment of the disclosure provides a communication device including a processor and a memory in which a computer program is stored; the processor executes a computer program stored in the memory so that the communication device performs the method described in the third aspect above.

In a thirteenth aspect, the embodiment of the disclosure provides a communication device including a processor and an interface circuit for receiving code instructions and transmitting them to the processor, and the processor is used for running the code instructions to enable the device to perform the method described in the first aspect.

In a fourteenth aspect, the embodiment of the disclosure provides a communication device including a processor and an interface circuit for receiving code instructions and transmitting them to the processor, and the processor is used for running the code instructions to enable the device to perform the method described in the second aspect.

In the fifteenth aspect, the embodiment of the disclosure provides a communication device including a processor and an interface circuit for receiving code instructions and transmitting them to the processor, and the processor is used for running the code instructions to cause the device to perform the method described in the third aspect.

In the sixteenth aspect, the disclosed embodiment provides a communication system including a communication device described in the fourth aspect to a communication device described in the sixth aspect, or the system including a communication device described in the seventh aspect to a communication device described in the ninth aspect, or the system including a communication device described in the tenth aspect to a communication device described in the twelfth aspect, or the system including a communication device described in the thirteenth aspect to a communication device described in the fifteenth aspect.

In the seventeenth aspect, the embodiment of the present invention provides a computer-readable storage medium for storing instructions for the network device and/or the terminal device, and when the instructions are executed, the network device performs the method described in the first aspect, and/or the terminal device performs the method described in the second aspect, and/or the terminal device performs the method described in the third aspect.

In the eighteenth aspect, the present disclosure also provides a computer program product that includes a computer program, and when it runs on a computer, it enables the computer to perform the method described in any one of the first to third aspects above.

In the nineteenth aspect, the present disclosure provides a chip system. The chip system includes at least one processor and an interface, which are used to support a network device to implement the functions involved in the method described in the first aspect, and/or support a terminal device to implement the functions involved in the method described in the second aspect, and/or support a terminal device to implement the functions involved in the method described in the third aspect, for example, to determine or process at least one of the data and information involved in the above method. In a possible design, the chip system also includes a memory, and the memory is used to store necessary computer programs and data for the source secondary node. The chip system can be composed of chips, or it can include chips and other discrete devices.

In the twentieth aspect, the present disclosure provides a computer program that, when running on a computer, enables the computer to perform the method described in any one of the first to third aspects above.

### BRIEF DESCRIPTION OF THE DRAWINGS

The foregoing and/or additional aspects and advantages of this disclosure will become apparent and easily understood from the description of the embodiments below in combination with the accompanying drawings, where:

FIG. 1 is a schematic diagram of the architecture of a communication system provided in an embodiment of the present disclosure;

FIG. 2 is a schematic diagram of the flow of the SL beam configuration method provided in another embodiment of the present disclosure;

FIG. 3 is a schematic diagram of the flow of the SL beam configuration method provided in an embodiment of the present disclosure;

FIG. 4 is a schematic diagram of the flow of the SL beam configuration method provided in another embodiment of the present disclosure;

FIG. 5 is an interactive schematic diagram of an SL beam configuration method provided in an embodiment of the present disclosure;

FIG. 6 is a schematic diagram of the flow of the SL beam configuration method provided in another embodiment of the present disclosure;

FIG. 7 is a schematic diagram of the flow of the SL beam configuration method provided in another embodiment of the present disclosure;

FIG. 8 is a schematic diagram of the flow of the SL beam configuration method provided in another embodiment of the present disclosure;

FIG. 9 is a schematic diagram of the flow of the SL beam configuration method provided in another embodiment of the present disclosure;

FIG. 10 is a schematic diagram of the flow of the SL beam configuration method provided in another embodiment of the present disclosure;

FIG. 11 is a schematic diagram of the flow of the SL beam configuration method provided in another embodiment of the present disclosure;

FIG. 12 is a schematic diagram of the flow of the SL beam configuration method provided in another embodiment of the present disclosure;

FIG. 13 is a schematic diagram of the flow of the SL beam configuration method provided in another embodiment of the present disclosure;

FIG. 14 is a schematic diagram of the flow of the SL beam configuration method provided in another embodiment of the present disclosure;

FIG. 15 is a schematic diagram of the flow of the SL beam configuration method provided in another embodiment of the present disclosure;

FIG. 16 is a schematic diagram of the flow of the SL beam configuration method provided in another embodiment of the present disclosure;

FIG. 17 is a schematic diagram of the flow of the SL beam configuration method provided in another embodiment of the present disclosure;

FIG. 18 is a schematic diagram of the flow of the SL beam configuration method provided in another embodiment of the present disclosure;

FIG. 19 is a schematic diagram of the flow of the SL beam configuration method provided in another embodiment of the present disclosure;

FIG. 20 is a schematic diagram of the structure of a communication apparatus provided in an embodiment of the present disclosure;

FIG. 21 is a schematic diagram of the structure of the communication apparatus provided in another embodiment of the present disclosure;

FIG. 22 is a schematic diagram of the structure of the communication apparatus provided in another embodiment of the present disclosure;

FIG. 23 is a block diagram of a communication apparatus provided in an embodiment of the present disclosure;

FIG. 24 is a schematic diagram of the structure of a chip provided in one embodiment of the present disclosure.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with the embodiments of the present disclosure. Rather, they are merely examples of apparatuses and methods consistent with some aspects of the embodiments of the present disclosure as detailed in the appended claims.

The terms used in the present disclosure are for the purpose of describing specific embodiments only and are not intended to limit the present disclosure. As used in the present disclosure and the appended claims, the singular forms “a/an,” “said” and “the” are intended to include the plural forms as well, unless the context clearly dictates otherwise. It should also be understood that the term “and/or” as used herein refers to and includes any or all possible combinations of at least one of the associated listed items.

It should be understood that although the terms first, second, third, etc. may be used to describe various information in the present disclosure, the information should not be limited to these terms. These terms are only used to distinguish information of the same type from each other. For example, without departing from the scope of the present disclosure, the first information may also be called second information, and similarly, the second information may also be called first information. Depending on the context, the word “if” as used herein may be interpreted as “when” or “upon” or “in response to determining.”

The embodiments of the present disclosure are described in detail below. Examples of the embodiments are shown in the accompanying drawings, where the same or similar reference numerals throughout indicate the same or similar elements. The embodiments described by referring to the accompanying drawings below are exemplary and are intended to explain the present disclosure and should not be construed as limiting the present disclosure.

For ease of understanding, the terms involved in the present application are first introduced.
1. Sidelink (SL)
There are two modes of sidelink communication, one is called UE-to-UE discovery and the other is UE-to-UE communication. Sidelink uses uplink resources and uplink physical channels similar to cellular networks (LTE) for data exchange.
2. Ratio Resource Control (RRC) signaling
RRC signaling can provide the function of parameter configuration for the underlying protocol entities of the access network; it is responsible for functions such as measurement and control related to the mobility management of terminal devices.
3. Medium Access Control-Control Element (MAC CE) signaling
MAC CE is a way for terminal devices and network devices to exchange control information, and the information exchanged is about the control information of the MAC layer.

In order to better understand a method for determining the side link duration disclosed in the embodiments of the present application, the communication system applicable to the embodiments of the present application is first described below.

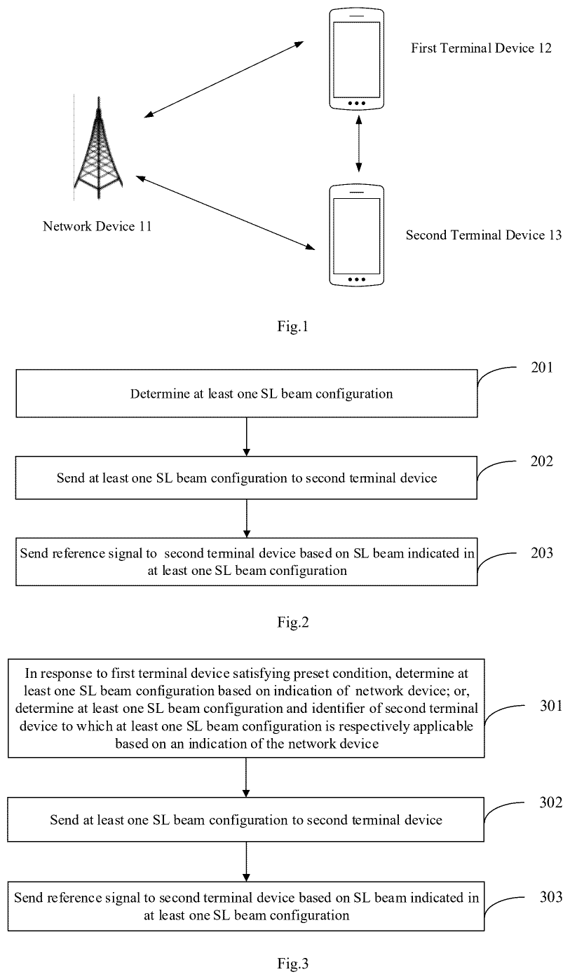

See FIG. 1, which is a schematic diagram of the architecture of a communication system provided in the embodiment of the present disclosure. The communication system may include, but is not limited to, a network device, a first terminal device and a second terminal device, wherein the first terminal device communicates with the second terminal device through an SL, and the number and form of devices shown in FIG. 1 are only for example and do not constitute a limitation of the embodiments of the present disclosure, and two or more network device and two or more terminal device may be included in practical application. The communication system shown in FIG. 1 takes including a network device 11, a first terminal device 12, and a second terminal device 13 as an example.

It should be noted that the technical solutions of the embodiments of this disclosure can be applied to various communication systems. For example: Long Term Evolution (LTE) systems, 5th generation (5G) mobile communication systems, 5G New Radio (NR) systems, or other future new mobile communication systems, etc.

The network device 11 in the embodiment of the present disclosure is an entity on the network side for transmitting or receiving signals. For example, network device 11 can be evolved NodeB (eNB), transmission reception point (TRP), next generation NodeB (gNB) in NR systems, base stations in other future mobile communication systems, or access nodes in wireless fidelity (WiFi) systems. The embodiments of the present disclosure do not limit the specific technology and specific device form used in the network device. The network device provided in the embodiment of the present disclosure may be composed of a central unit (CU) and a distributed unit (DU), wherein the CU may also be called a control unit, and the structure of the CU-DU can be used to split the protocol layer of the network device, such as a base station, and the functions of part or all of the protocol layers are centrally controlled in the CU, the DU is centrally controlled by the CU.

The first terminal device 12 and the second terminal device 13 in the embodiment of the present disclosure may be an entity on the user side for receiving or transmitting signals, such as a mobile phone. Terminal device can also be called terminal, user equipment (UE), mobile station (MS), mobile terminal (MT), etc. The terminal device can be a car with communication function, a smart car, a mobile phone, a wearable device, a tablet computer (Pad), a computer with wireless sending and receiving function, a virtual reality (VR) terminal device, an augmented reality (AR) terminal device, a wireless terminal device in industrial control, Wireless terminal device in self-driving, wireless terminal device in remote medical surgery, wireless terminal device in smart grid, wireless terminal device in transportation safety, wireless terminal device in smart city, smart home (smart). home) and so on. The embodiments of the present disclosure do not limit the specific technology and specific device form used in the terminal device.

It is understandable that the communication system described in the embodiments of the present disclosure is for the purpose of more clearly illustrating the technical solutions of the embodiments of the present disclosure, and does not constitute a limitation on the technical solutions provided in the embodiments of the present disclosures, and those skilled in the art can know that with the evolution of the system architecture and the emergence of new business scenarios, the technical solutions provided in the embodiments of the present disclosure are equally applicable to similar technical problems.

And, in the embodiments of the present disclosure, the meanings of “obtain from.” or “obtain sent by.”can all be understood as “receive from.”or “receive sent by.”.

And, in the embodiments of the present disclosure, the meaning of “based on” mentioned can all be understood as “according to”or “considering”.

The SL beam configuration method, apparatus, device and storage medium provided in the embodiment of the present disclosure are described in detail with reference to the accompanying drawings below.

FIG. 2 is a schematic diagram of the flow of an SL beam configuration method provided in the embodiments of the present disclosure, which is executed by a first terminal device, and as shown in FIG. 2, the SL beam configuration method may include the following steps:

Step 201: Determine at least one SL beam configuration.

Wherein, in one embodiment of the present disclosure, the SL beam configuration may include first indication information indicating an SL beam; and a reference signal carried by the SL beam.

In one embodiment of the present disclosure, the SL beam is the beam used for communication between the first terminal device and the second terminal device. Wherein, the second terminal device is a terminal device connected with the first terminal device through an SL. Further, the first indication described above can be a (SL)Transmission Configuration Indicator (TCI) corresponding to the SL beam, and/or, the first indication can also be an index identifier for the SL.

Step 202, send the at least one SL beam configuration to a second terminal device.

Wherein, in one embodiment of the present disclosure, the first terminal device sends at least one SL beam configuration to the second terminal device to inform the second terminal device of the SL beam configuration corresponding to the SL beam for the previous communication with the first terminal device, so as to facilitate subsequent joint management of the SL beam by the first terminal device and the second terminal device.

Step 203, send a corresponding reference signal to the second terminal device based on the SL beam indicated in the at least one SL beam configuration.

Wherein, the first terminal device can specifically transmit a reference signal to the second terminal device by carrying it on the SL beam corresponding to the reference signal. For example, assuming that SL beam #1 corresponds to carrying reference signal #1, the first terminal device can transmit reference signal #1 on SL beam #1 to the second terminal device.

In one embodiment of the present disclosure, the first terminal device sends a corresponding reference signal to the second terminal device based on the SL beam indicated in the at least one SL beam configuration, so that the second terminal device can measure the reference signal to obtain a reference signal measurement report and feed it back to the first terminal device. Thus, the first terminal device can determine which specific SL beam to activate for communication with the second terminal device based on the reference signal measurement report, thereby realizing the configuration of the SL beam between the first terminal device and the second terminal device.

In summary, in the SL beam configuration method provided in the present embodiment, the first terminal device will first determine at least one SL beam configuration, and the beam configuration includes: first indication information indicating the SL beam, and a reference signal carried by the SL beam. After that, the first terminal device will send the at least one SL beam configuration to the second terminal device, and the first terminal device and the second terminal device communicate based on SL. Moreover, the first terminal device will also send the corresponding reference signal to the second terminal device based on the SL beam indicated in the at least one SL beam configuration. It can be seen that in the present embodiments, after the first terminal device and the second terminal device exchange the SL beam configuration, the first terminal device will send the corresponding reference signal to the second terminal device based on the SL beam indicated in the at least one SL beam configuration, so that the second terminal device can measure the reference signal to obtain a reference signal measurement report and feed it back to the first terminal device. Then, the first terminal device can determine which specific SL beam to activate for communication with the second terminal device based on the reference signal measurement report, thereby realizing the configuration of the SL beam between the first terminal device and the second terminal device. Therefore, the embodiments of this disclosure provide an SL beam configuration method between directly connected terminal devices for SL, enabling SL transmission to support beam communication.

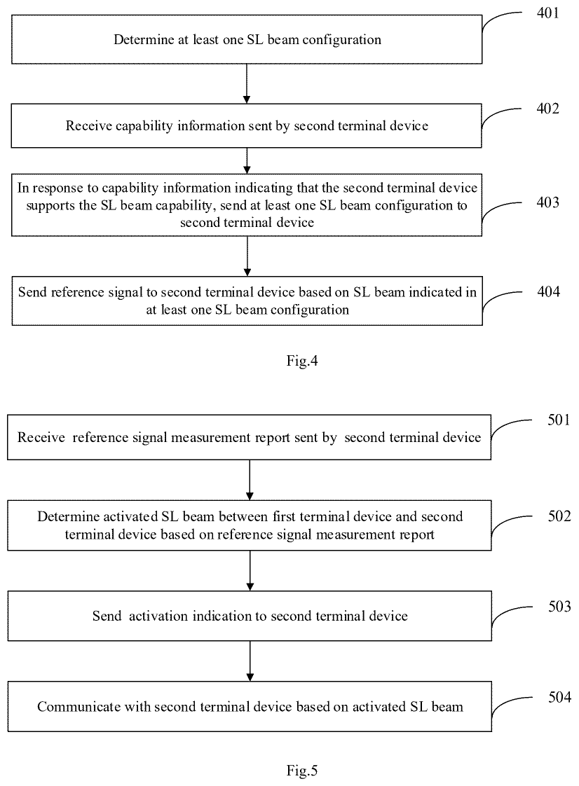

FIG. 3 is a schematic diagram of the flow of an SL beam configuration method provided in the embodiment of the present disclosure, which is executed by a first terminal device, and as shown in FIG. 3, the SL beam configuration method may include the following steps:

step 301, in response to a first terminal device satisfies preset conditions, determine at least one SL beam configuration based on the indication of the network device, or, based on the indication of the network device, determine at least one SL beam configuration and an identifier of the second terminal device to which at least one SL beam configuration respectively applicable.

In an embodiment of the present disclosure, the preset conditions may include at least one of the following:
the first terminal device is in a connected state;
the first terminal device allocates SL transmission resources based on the dynamic scheduling of the network device.

And, in one embodiment of the present disclosure, the method for determining at least one SL beam configuration based on the indication of the network device, or determining at least one SL beam configuration and an identifier of a second terminal device to which the at least one SL beam configuration is respectively applicable based on the indication of the network device may include the following steps:

Step 1: Report at least one of the following to the network device:
whether the first terminal device supporting SL beam capability;
whether the second terminal device supporting SL beam capability;
the identifier of the second terminal device;
Among them, the above mentioned SL beam capability can include at least one of the following:
SL beam measurement capability;
SL beam measurement reporting capability;
SL beam failure assessment capability;
SL beam failure recovery capability.

Step 2, in response to the first terminal device and the second terminal device both supporting SL beam capability, receive a second indication information sent by the network device.
wherein, in one embodiment of the present disclosure, the second indication information indicating the at least one SL beam configuration; or, the second indication information indicating the at least one SL beam configuration and the identifier of the second terminal device to which the at least one SL beam configuration is respectively applicable.

For example, the method by which the second indication information indicates at least one SL beam configuration may be: the second indication information directly includes the specific configuration content of at least one SL beam configuration; and/or, the second indication information indicates at least one SL beam configuration by carrying the index identifier of at least one SL beam configuration.

It should be noted that, in one embodiment of the present disclosure, when the first terminal device and/or the second terminal device does not support the SL beam capability, the network device will not indicate at least one SL beam configuration and/or the identifiers of the second terminal devices to which the at least one SL beam configuration is respectively applicable to the first terminal device.

Step 3: Determine at least one SL beam configuration indicated by the network device based on the second indication information, or determine at least one SL beam configuration and an identifier of the second terminal devices to which the at least one SL beam configuration is respectively applicable.

In one embodiment of the present disclosure, the first terminal device can specifically determine at least one SL beam configuration indicated by the second indication information as the at least one SL beam configuration indicated by the network device; or, the first terminal device can determine at least one SL beam configuration and an identifier of the second terminal device to which the at least one SL beam configuration is respectively applicable indicated by the second indication information as the at least one SL beam configuration and the identifier of the second terminal devices to which the at least one SL beam configuration is respectively applicable indicated by the network device.

And, in another embodiment of the present disclosure, above mentioned method for determining at least one SL beam configuration based on the indication of the network device, or determining at least one SL beam configuration and an identifier of the second terminal device to which the at least one SL beam configuration is respectively applicable based on the indication of the network device may include the following steps:

Step a: In response to determining that the network device supports the configuration of the SL beam configuration, report at least one of the following to the network device:
at least one SL beam configuration supported by the first terminal device;
an index identifier corresponding to the at least one SL beam configuration supported by the first terminal device.

Wherein, in one embodiment of the present disclosure, the method by which the first terminal device determines whether the network device supports configuration of the SL beam configuration may include:
When it is determined that the network device has configured the SL beam configuration to the first terminal device through the system information and/or Radio Resource Control (RRC) reconfiguration message, it is determined that the network device supports configuration of the SL beam configuration, otherwise, it is determined that the network device does not support configuration of the SL beam configuration.

Step b, receive a third indication information sent by the network device.

In one embodiment of the present disclosure, the third indication information indicates the at least one SL beam configuration; or, the third indication information indicates the at least one SL beam configuration and the identifier of the second terminal device to which the at least one SL beam configuration is respectively applicable, wherein the at least one SL beam configuration indicated by the third indication information is any one or more of the SL beam configurations reported by the terminal device.

For example, in one embodiment of the present disclosure, the third indication information may indicate at least one SL beam configuration by carrying any one or any plurality of index identifiers reported by the first terminal device; and/or the third indication may indicate at least one SL beam configuration by including the specific configuration content of any one or more SL beam configurations reported by the first terminal device.

Step c, determine at least one SL beam configuration indicated by the network device based on the third indication information, or determine at least one SL beam configuration and the identifier of the second terminal device to which the at least one SL beam configuration is respectively applicable.

In one embodiment of the present disclosure, the first terminal device can specifically determine at least one SL beam configuration indicated by the third indication information as the at least one SL beam configuration indicated by the network device; or, the first terminal device can determine at least one SL beam configuration and the identifiers of the second terminal devices to which the at least one SL beam configuration is respectively applicable indicated by the third indication information as the at least one SL beam configuration and the identifier of the second terminal devices to which the at least one SL beam configuration is respectively applicable indicated by the network device.

In addition, it should be noted that, in one embodiment of the present disclosure, the network device may indicate only to the first terminal device at least one SL beam configuration, but not to the first terminal device the identifier of the second terminal device to which the least one SL beam configuration is respectively applicable, and at this time, the at least one SL beam configuration indicated by the network device is applicable to all second terminal devices SL connected with the first terminal device.

Step 302, send at least one SL beam configuration to the second terminal device.

Wherein, in one embodiment of the present disclosure, the first terminal device informs the second terminal device of the SL beam configuration corresponding to the SL beam of its previous communication with the first terminal device by sending at least one SL beam configuration to the second terminal device, so as to facilitate the subsequent first terminal device and the second terminal device to jointly manage the SL beam.

And, in one embodiment of the present disclosure, in response to the network device indicating the identifier of the second terminal device, the first terminal device shall send a corresponding SL beam configuration to the corresponding second terminal device based on the identifier of the second terminal device indicated by the network device. For example, assuming that the first terminal device obtains the SL beam configuration #1 and the identifier of the second terminal device to which the SL beam configuration #1 is applicable as #1 from the indication of the network device, at this time, the first terminal device needs to send the SL beam configuration #1 to the second terminal device #1 based on the identifier #1 of the second terminal device.

In another embodiment of the present disclosure, in response to the network device not indicating the identifier of the second terminal device, the first terminal device may send an SL beam configuration to any one or more of the second terminal devices to which its SL is connected.

Step 303, send a corresponding reference signal to the second terminal device based on the SL beam indicated in at least one SL beam configuration.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 4 is a schematic diagram of the flow of an SL beam configuration method provided in the embodiment of the present disclosure, which is performed by a first terminal device, and as shown in FIG. 4, the SL beam configuration method may include the following steps:

Step 401: Determine at least one SL beam configuration.

Step 402, receive capability information sent by the second terminal device.

Wherein, in one embodiment of the present disclosure, the capability information may be used to indicate whether the second terminal device supports the SL beam capability;
This SL beam capability can include at least one of the following:
SL beam measurement capability;
SL beam measurement reporting capability;
SL beam failure assessment capability;
SL beam failure recovery capability.

And, in one embodiment of the present disclosure, the first terminal device may receive capability information sent by the second terminal device through SL RRC messages.

Step 403, in response to the capability information indicating that the second terminal device supports SL beam capability, sends at least one SL beam configuration to the second terminal device.

It should be noted that in one embodiment of the present disclosure, when the capability information indicates that the second terminal device does not support SL beam capability, the first terminal device does not send at least one SL beam configuration to the second terminal device.

Step 404, a corresponding reference signal is sent to the second terminal device based on the SL beam indicated in at least one SL beam configuration.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 5 is a schematic diagram of the flow of an SL beam configuration method provided in the embodiment of the present disclosure, which is executed by a first terminal device, and as shown in FIG. 5, the SL beam configuration method may include the following steps:

Step 501, receive a reference signal measurement report sent by the second terminal device.

Wherein, in one embodiment of the present disclosure, the reference signal measurement report may be obtained by the second terminal device by measuring a reference signal sent by the first terminal device. Further, the reference signal measurement report may include at least one of the following:
a reference signal measurement result;
a first indication information being used to indicate the SL beam corresponding to the measurement result of the reference signal (see the description above for a detailed description of the first indication information).

wherein, the above mentioned reference signal measurement result can include at least one of the following:
Reference Signal Received Power (RSRP);
Reference Signal Received Quality (RSRQ);
Signal-to-Interference plus Noise Ratio (SINR)

And, in one embodiment of the present disclosure, the first terminal device may receive a reference signal measurement report sent by the second terminal device through any one or more of the SL MAC CE signaling, sidelink control information (SCI), SL RRC message.

Step 502, determine an activated SL beam between the first terminal device and the second terminal device based on the reference signal measurement report.

Wherein, after one embodiment of the present disclosure, the first terminal device can independently determine to activate the SL beam. In another embodiment of the present disclosure, the first terminal device can also determine to activate the SL beam based on the indication of the network device. This part of the content will be described in detail in subsequent embodiments.

And, it should be noted that the activated SL beam should be one or more SL beams corresponding to at least one SL beam configuration determined by the first terminal device in step 201 mentioned above.

Step 503, send an activation indication to the second terminal device.

Wherein, in one embodiment of the present disclosure, the activation indication indicates that there is an activated SL beam, and the activation indication is used to instruct the second terminal device to activate the activated SL beam. The activation indication can indicate the activation of the SL beam by carrying the first indication (i.e., the TCI and/or index identifier) corresponding to the activated SL beam.

And, in one embodiment of the present disclosure, the first terminal device may send an activation indication to the second terminal device through any one or more of the SL MAC CE signaling, SCI, SL RRC messages.

Step 504, communicate with the second terminal device based on the activated SL beam.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 6 is a schematic diagram of the flow of an SL beam configuration method provided in the embodiment of the present disclosure, which is performed by a first terminal device, as shown in FIG. 6, and the SL beam configuration method may include the following steps:

Step 601, receive a reference signal measurement report sent by the second terminal device.

Step 602, the first terminal device independently determines the activated SL beam between the first terminal device and the second terminal device based on the reference signal measurement result in the reference signal measurement report.

Wherein, after one embodiment of the present disclosure, the first terminal device may independently determine the SL beam with the best reference signal measurement result as the active SL beam. In another embodiment of the present disclosure, the first terminal device may determine any one or more of the several SL beams with the top reference signal measurement results as the activated SL beam. In another embodiment of the present disclosure, the first terminal device may determine any one or more of the SL beams in which the reference signal measurement result is greater than a predetermined threshold as the activated SL beam.

Step 603, send a fourth indication information to the network device.

In one embodiment of the present disclosure, the fourth indication may include at least one of the following:
the activated SL beam independently determined by the first terminal device;
the reference signal measurement result corresponding to the activated SL beam;
an identifier of the second terminal device using the activated SL beam.
wherein, the first terminal device sends a fourth indication information to the network device to inform the network device which specific beam is the activated SL beam between it and the second terminal device, so that when the subsequent network device schedules SL resources for the first terminal device and/or the second terminal device, it can schedule SL resources based on the activated SL beam.

In addition, it should be noted that in one embodiment of the present disclosure, specifically, when the first terminal device determines that the network device supports the configuration of the SL beam configuration, the first terminal device sends a fourth indication information to the network device. Wherein, the method for determining whether the network device supports the configuration of the SL beam configuration by the first terminal device can be described with reference to the above embodiment.

Step 604, send an activation indication to the second terminal device.

Wherein, in one embodiment of the present disclosure, the activation indication indicates that there is an activated SL beam, and the activation indication is used to instruct the second terminal device to activate the activated SL beam. The activation indication can indicate the activation of the SL beam by carrying the first indication (i.e., the TCI and/or index identifier) corresponding to the activated SL beam.

Step 605, communicate with the second terminal device based on the activated SL beam.

In summary, in the SL beam configuration method provided in the present embodiment, the first terminal device will first determine at least one SL beam configuration, and the beam configuration includes: first indication information indicating the SL beam, and a reference signal correspondingly carried by the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

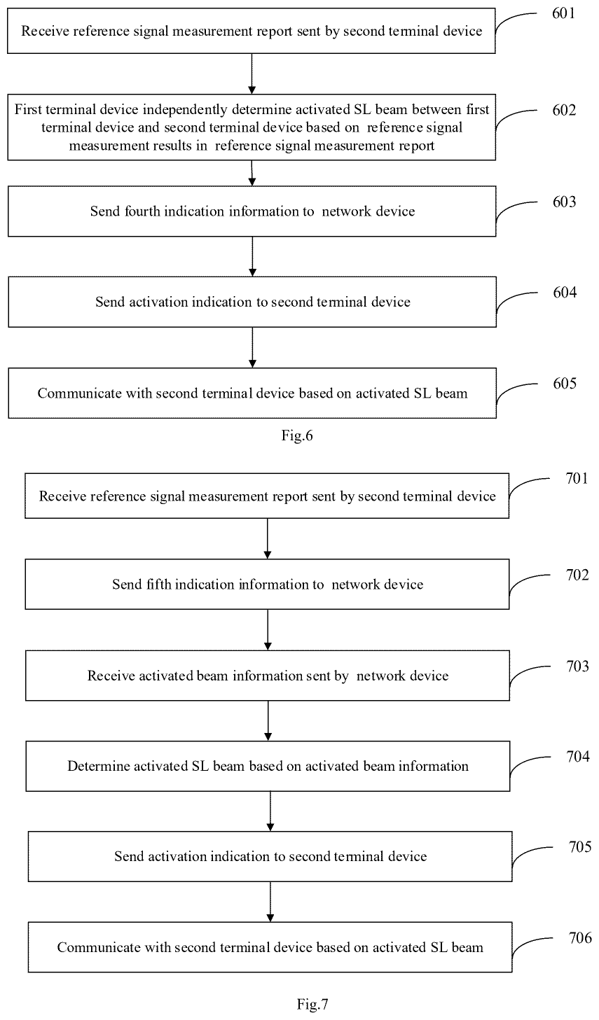

FIG. 7 is a schematic diagram of the flow of an SL beam configuration method provided in the embodiment of the present disclosure, which is executed by a first terminal device, as shown in FIG. 7, and the SL beam configuration method may includes the following steps:

Step 701, receive a reference signal measurement report sent by the second terminal device.

Step 702, send a fifth indication information to the network device.

Wherein, after an embodiment of the present disclosure, the fifth indication information may include a reference signal measurement report sent by the second terminal device and an identifier of the second terminal device corresponding to the reference signal measurement report. and, by sending a fifth indication to the network device, the network device can determine the specific activated SL beam based on the reference signal measurement report and indicate it to the first terminal device.

In addition, it should be noted that in one embodiment of the present disclosure, specifically, when the first terminal device determines that the network device supports the configuration of the SL beam configuration, the first terminal device sends a fifth indication to the network device. Wherein, the method for determining whether the network device supports the configuration of the SL beam configuration by the first terminal device can be described with reference to the above embodiment.

Step 703, receive activated beam information sent by the network device.

Wherein, in one embodiment of the present disclosure, the activated beam information includes at least one of the following:
an activated SL beam between the first end device and the second end device as determined by the network device (and/or the first indication of the activated SL beam (i.e., TCI and/or index identifier));
an identifier of the second terminal device corresponding to the activated SL beam.

Wherein, in one embodiment of the present disclosure, the activated SL beam may be the SL beam with the best reference signal measurement result. In another embodiment of the present disclosure, the activated SL beam may be any one or more of the several SL beams with the highest reference signal measurements determined to be the activated SL beam. In another embodiment of the present disclosure, the first terminal device may determine any one or more of the SL beams in which the reference signal measurement result are greater than a predetermined threshold as the activated SL beam.

In addition, it should be noted that in one embodiment of the present disclosure, the activation beam information may indicate only the activation of the SL beam, but not the identifier of the second terminal device corresponding to the activation of the SL beam. In this case, the activated SL beam is applicable to any one or more second terminal devices connected to the first terminal device SL.

Step 704, determine the activated SL beam based on the activated beam information.

Step 705, send an activation indication to the second terminal device.

Wherein, in one embodiment of the present disclosure, the activation indication indicates that there is an activated SL beam, and the activation indication is used to instruct the second terminal device to activate the activated SL beam. Further, the activation indication may indicate the activated SL beam by carrying the first indication (i.e., TCI and/or index identifier) corresponding to the activated SL beam.

And, in one embodiment of the present disclosure, when the identifier of a second terminal device is indicated in the activation beam information sent by a network device, the first terminal device sends an activation indication to the second terminal device corresponding to the identifier; In another embodiment of the present disclosure, when the identifier of the second terminal device is not indicated in the activation beam information sent by the network device, the first terminal device may send an activation indication to any one or more second terminal devices to which its SL is connected.

Step 706, communicate with the second terminal device based on the activated SL beam.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 8 is a schematic diagram of the flow of an SL beam configuration method provided in the embodiment of the present disclosure, which is executed by a second terminal device, and as shown in FIG. 8, the SL beam configuration method may include the following steps:

Step 801, determine at least one SL beam configuration applicable to the first terminal device.
Wherein, in one embodiment of the present disclosure, the first terminal device communicates with the second terminal device based on SL.
and the SL beam configuration includes: a first indication indicating the SL beam, and a reference signal corresponding to the SL beam carried;

Step 802, receive a reference signal sent by the first terminal device based on the at least one SL beam configuration.
Wherein, a detailed description of steps 801-802 can be referred to the above embodiment.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

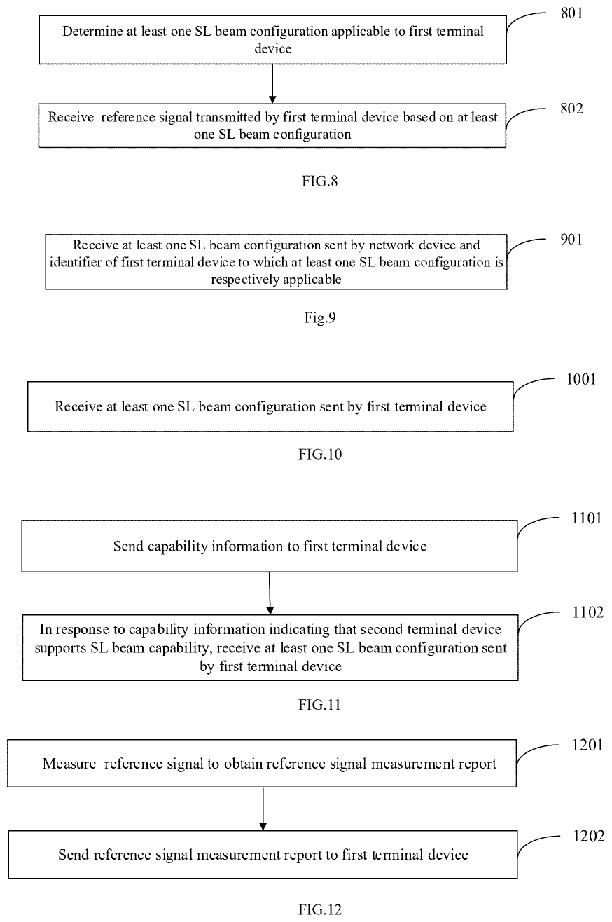

FIG. 9 is a schematic diagram of the flow of an SL beam configuration method provided in the embodiment of the present disclosure, which is executed by a second terminal device, and as shown in FIG. 9, the SL beam configuration method may include the following steps:

Step 901, Receive at least one SL beam configuration and an identifier of the first terminal device to which the at least one SL beam configuration is respectively applicable, sent by the network device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 10 is a schematic diagram of the flow of an SL beam configuration method provided in the present embodiment, which is executed by a second terminal device, as shown in FIG. 10, and the SL beam configuration method may include the following steps:

Step 1001, receive at least one SL beam configuration sent by the first terminal device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

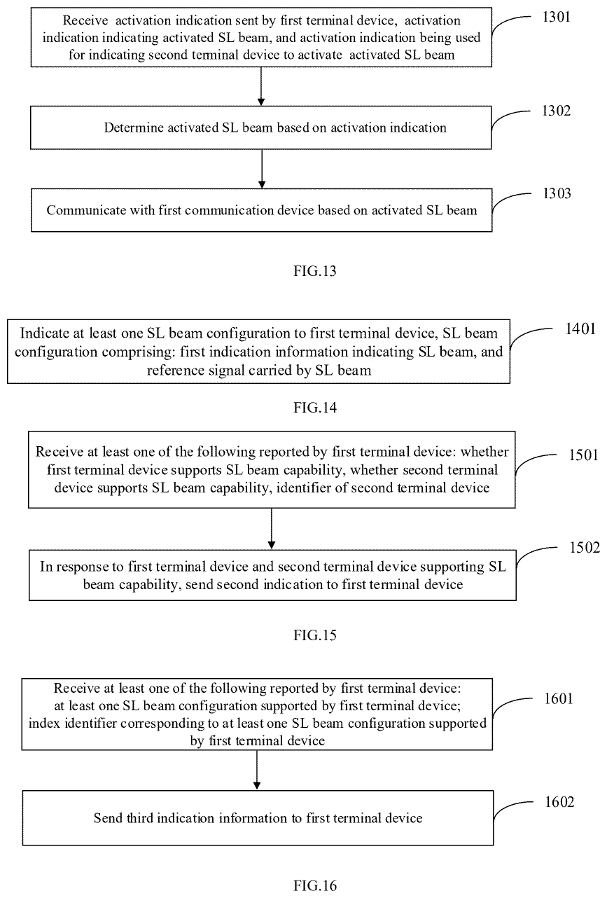

FIG. 11 is a schematic diagram of the flow of an SL beam configuration method provided in the embodiment of the present disclosure, which is executed by a second terminal device, and as shown in FIG. 11, the SL beam configuration method may include the following steps:

Step 1101, send capability information to the first terminal device.

Step 1102, in response to capability information indicating that the second terminal device supports SL beam capability, receive at least one SL beam configuration sent by the first terminal device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 12 is a schematic diagram of the flow of an SL beam configuration method provided in the embodiment of the present disclosure, which is executed by a second terminal device, and as shown in FIG. 12, the SL beam configuration method may include the following steps:

step 1201, measure the reference signal to obtain a reference signal measurement report.

step 1202, send the reference signal measurement report to the first terminal device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 13 is a schematic diagram of the flow of an SL beam configuration method provided in the embodiment of the present disclosure, which is executed by a second terminal device, and as shown in FIG. 13, the SL beam configuration method may include the following steps:

step 1301, receive an activation indication sent by the first terminal device, the activation indication indicates that an SL beam is activated, and the activation indication is used for instructing the second terminal device to activate the activated SL beam;

step 1302, determine the activated SL beam based on the activation indication;

step 1303, communicate with the first communication device based on the activated SL beam.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

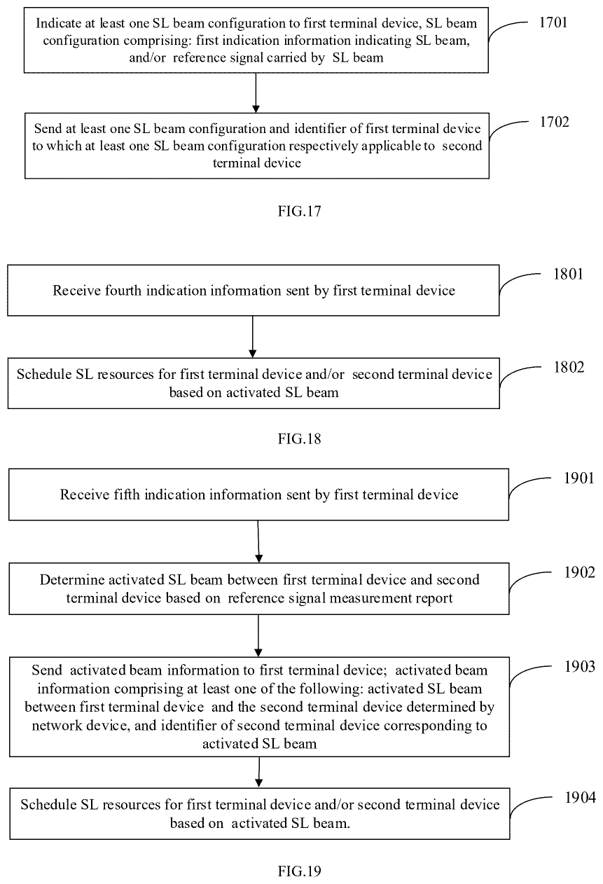

FIG. 14 is a schematic diagram of the flow of an SL beam configuration method provided in the embodiment of the present disclosure, which is executed by a network device, and as shown in FIG. 14, the SL beam configuration method may include the following steps:

step 1401, indicate at least one SL beam configuration to the first terminal device, the SL beam configuration includes: first indication information indicating the SL beam, and, the reference signal that the SL beam correspondingly carries.

Wherein, in one embodiment of the present disclosure, the network device may indicate only to the first terminal device at least one SL beam configuration so that the first terminal device may send at least one SL beam configuration to at least one second terminal device to which its SL is connected. Alternatively, the network device may further indicate to the first terminal device the identifier of at least one second terminal device to which each SL beam configuration applies, so that the first terminal device may send at least one SL beam configuration to the corresponding second terminal device based on that identifier.

Further, in one embodiment of the present disclosure, at least one SL beam configuration may be carried in system information and/or an RRC reconfiguration message to the first terminal device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 15 is a schematic diagram of the flow of an SL beam configuration method provided in the embodiment of the present disclosure, which is executed by a network device, and as shown in FIG. 15, the SL beam configuration method may include the following steps:

step 1501, receive at least one of the following reported by the first terminal device:
whether the first terminal device supports SL beam capability;
whether the second terminal device supports the SL beam capability, wherein the second terminal device is a terminal device communicating with the first terminal device through SL;
an identifier of the second terminal device;

step 1502, in response to the first terminal device and the second terminal device both supporting SL beam capability, send a second indication information to the first terminal device, the second indication information indicating that there is at least one SL beam configuration; or the second indication information indicating that there is at least one SL beam configuration and an identifier of a second terminal device to which at least one SL beam configuration is respectively applicable.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 16 is a schematic diagram of the flow of an SL beam configuration method provided in the embodiment of the present disclosure, which is executed by a network device, as shown in FIG. 16, and the SL beam configuration method may include the following steps:

step 1601, receive at least one of the following reported by the first terminal device:
at least one SL beam configuration supported by the first terminal device;
an index identifier corresponding to at least one SL beam configuration supported by the first terminal device;

step 1602, send a third indication information to the first terminal device, and the third indication information indicates that there is at least one SL beam configuration; or, the third indication indicates that there is at least one SL beam configuration and an identifier of a second terminal device to which the at least one SL beam configuration is respectively applicable, wherein the at least one SL beam configuration indicated by the third indication information is any one or more of the SL beam configurations reported by the terminal device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

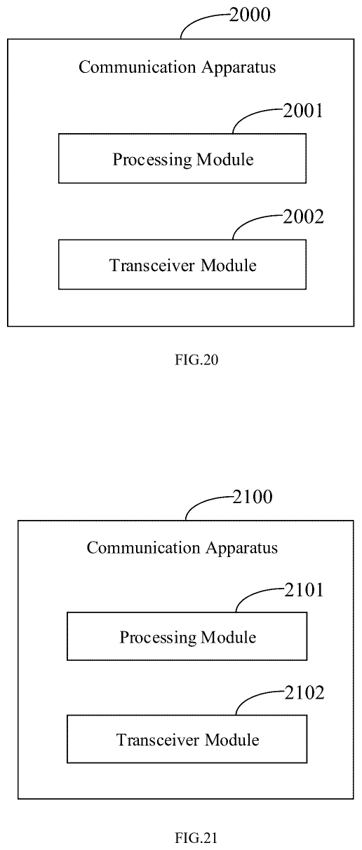

FIG. 17 is a schematic diagram of the flow of an SL beam configuration method provided in the embodiment of the present disclosure, which is performed by a network device, as shown in FIG. 17, and the SL beam configuration method may include the following steps:

step 1701, indicate at least one SL beam configuration to the first terminal device, the SL beam configuration includes: first indication information indicating the SL beam, and, the reference signal that the SL beam correspondingly carries.

step 1702, send at least one SL beam configuration and an identifier of the first terminal device to which the at least one SL beam configuration is respectively applicable to the second terminal device.
wherein, in one embodiment of the present disclosure, the network device may send at least one SL beam configuration to the first terminal device and the second terminal device respectively, wherein, when the network device sends at least one SL beam configuration to the first terminal device, it may further send the identifier of the first terminal device to which the at least one SL beam configuration is applicable to the first terminal device; In addition, when a network device sends at least one SL beam configuration to the second end device, it may further send the identifier of the second end device to which at least one SL beam configuration is applicable to the second end device.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 18 is a schematic diagram of the flow of an SL beam configuration method provided in the embodiment of the present disclosure, which is executed by a network device, as shown in FIG. 18, and the SL beam configuration method may include the following steps:

step 1801, receive a fourth indication information sent by the first terminal device.
Wherein, in one embodiment of the present disclosure, the fourth indication may include at least one of the following:
an activated SL beam independently determined by the first terminal device;
a reference signal measurement result corresponding to the activated SL beam;
an identifier of the second terminal device using the activated SL beam.

step 1802, schedule SL resources for the first terminal device and/or the second terminal device based on the activated SL beam.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 19 is a schematic diagram of the flow of an SL beam configuration method provided in the embodiment of the present disclosure, which is executed by a network device, and as shown in FIG. 19, the SL beam configuration method may include the following steps:

step 1901, receive a fifth indication information sent by the first terminal device.
Wherein, in an embodiment of the present disclosure, the fifth indication information includes a reference signal measurement report and an identifier of a second terminal device corresponding to the reference signal measurement report.

step 1902, determine an activated SL beam between the first terminal device and the second terminal device based on the reference signal measurement report;

step 1903, send activated beam information to the first terminal device; The activated beam information includes at least one of the following: an activated SL beam between the first terminal device and the second terminal device determined by the network device, and an identifier of the second terminal device corresponding to the activated SL beam.

step 1904, schedule SL resources for the first terminal device and/or the second terminal device based on the activated SL beam.

In summary, in the SL beam configuration method provided in the present embodiment, the first terminal device will first determine at least one SL beam configuration, and the beam configuration includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

FIG. 20 is a schematic diagram of the structure of a communication apparatus provided in the embodiment of the present disclosure, as shown in FIG. 20, the apparatus may include:
a processing module, configured to determine at least one SL beam configuration, wherein the SL beam configuration includes: first indication information indicating the SL beam, and, a reference signal corresponding to the SL beam;
a transceiver module, configured to send at least one SL beam configuration to a second terminal device, and a first terminal device communicates with the second terminal device based on the SL;
the transceiver module is used for sending a corresponding reference signal to the second terminal device based on the SL beam indicated in at least one SL beam configuration.

In summary, in the communication apparatus provided in the embodiment of the present disclosure, the first terminal device first determines at least one SL beam configuration, which includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

Optionally, in one embodiment of the present disclosure, the first indication information is the transmission configuration indication TCI corresponding to the SL beam; and/or
The first indication information is an index identifier corresponding to the SL beam.

Optionally, in one embodiment of the present disclosure, in response to the first terminal device being in a connected state, and/or, the first terminal device allocates SL sending resources based on the dynamic scheduling of the network device, and the processing module is further configured to:
Determine at least one SL beam configuration based on the indications of the network device; or
Determine at least one SL beam configuration and the identifier of the second terminal device to which at least one SL beam configuration is respectively applicable based on the indication of the network device.

Optionally, in one embodiment of the present disclosure, the apparatus is also used to:
Report at least one of the following to the network device:
whether the first terminal device supports SL beam capability;
whether the second terminal device supports SL beam capability;
the identifier of the second terminal device;
The SL beam capability includes at least one of the following:
SL beam measurement capability;
SL beam measurement reporting capability;
SL beam failure assessment capability;
SL beam failure recovery capability.

Optionally, in one embodiment of the present disclosure, the processing module is further configured to:
in response to the first terminal device and the second terminal device both supporting SL beam capability, receive a second indication information sent by the network device, and the second indication information indicating at least one SL beam configuration; or, the second indication information indicating that there is at least one SL beam configuration and the identifier of the second terminal device to which the at least one SL beam configuration is respectively applicable;
determining at least one SL beam configuration, or determining at least one SL beam configuration and the identifier of the second terminal device to which at least one SL beam configuration is respectively applicable, indicated by the network device based on the second indication information.

Optionally, in one embodiment of the present disclosure, the apparatus is also used for:
In response to determining that the network device supports the configuration of the SL beam configuration, report at least one of the following to the network device:
at least one SL beam configuration supported by the first terminal device;
an index identifier corresponding to at least one SL beam configuration supported by the first terminal device.

Optionally, in one embodiment of the present disclosure, the processing module is further configured to:
receive a third indication information sent by the network device, and the third indication indicating that there is at least one SL beam configuration; or, the third indication indicates that there is at least one SL beam configuration and the identifier of a second terminal device to which the at least one SL beam configuration is respectively applicable, wherein the at least one SL beam configuration indicated by the third indication information is any one or more of the SL beam configurations reported by the terminal device;
determining at least one SL beam configuration, or determining at least one SL beam configuration and the identifier of a second terminal device to which at least one SL beam configuration is respectively applicable, indicated by the network device based on the third indication information.

Optionally, in one embodiment of the present disclosure, the third indication information indicates at least one SL beam configuration by carrying any one or more index identifiers reported by the first terminal device.

Optionally, in one embodiment of the present disclosure, if the network device does not indicate the identifier of the second terminal device, the SL beam configuration indicated by the network device is applicable to all second terminal devices connected to the first terminal device through SL.

Optionally, in one embodiment of the present disclosure, the transceiver module is also used to:
In responding to the network device indicating the identifier of the second terminal device, send a corresponding SL beam configuration to the corresponding second terminal device based on the identifier of the second terminal device.

Optionally, in one embodiment of the present disclosure, the apparatus is also configured to:
receive capability information sent by the second terminal device, and the capability information is used for indicating whether the second terminal device supports SL beam capability;
The SL beam capability includes at least one of the following:
SL beam measurement capability;
SL beam measurement reporting capability;
SL beam failure assessment capability;
SL beam failure recovery capability.

Optionally, in one embodiment of the present disclosure, the transceiver module is also configured to:
In response to the capability information indicating that the second terminal device supports the SL beam capability, send the SL beam configuration to the second terminal device.

Optionally, in one embodiment of the present disclosure, the apparatus is also configured to:
receive a reference signal measurement report sent by the second terminal device;
determine an activated SL beam between the first terminal device and the second terminal device based on the reference signal measurement report.

Optionally, in one embodiment of the present disclosure, the reference signal measurement report includes at least one of the following:
a reference signal measurement result;
a first indication information for indicating the SL beam corresponding to the reference signal measurement result.

Optionally, in one embodiment of the present disclosure, the reference signal measurement result includes at least one of the following:
Reference signal received power RSRP;
Reference signal reception quality RSRQ;
Signal-to-interference-to-noise ratio SINR.

Optionally, in one embodiment of the present disclosure, the device is also used for:

The first terminal device independently determines the activated SL beam between the first terminal device and the second terminal device based on the reference signal measurement results in the reference signal measurement report.

Optionally, in one embodiment of the present disclosure, the apparatus is also configured to:
send a fourth indication to the network device, and the fourth indication information includes at least one of the following:
an activated SL beam independently determined by the first terminal device;
a reference signal measurement result corresponding to the activated SL beam;
an identifier of the second terminal device using the activated SL beam.

Optionally, in one embodiment of the present disclosure, the apparatus is also configured to:
send a fifth indication to the network device, the fifth indication information includes the reference signal measurement report and the identifier of the second terminal device corresponding to the reference signal measurement report.

Optionally, in one embodiment of the present disclosure, the apparatus is also configured to:
receive activated beam information sent by the network device; the activated beam information includes at least one of the following: an activated SL beam between the first terminal device determined by the network device and the second terminal device, and an identifier of the second terminal device corresponding to the activated SL beam;
determining the activated SL beam based on the activated beam information.

Optionally, in one embodiment of the present disclosure, the apparatus is also configured to:
In response to determining that the network device supports the configuration of the SL beam configuration, send a fourth or fifth indication to the network device.

Optionally, in one embodiment of the present disclosure, the apparatus is also configured to:
In response to determining that the network device has configured an SL beam configuration to the first terminal device through system information and/or radio resource control RRC reconfiguration messages, determine that the network device supports the configuration of the SL beam configuration.

Optionally, in one embodiment of the present disclosure, the apparatus is also configured to:
Send an activation indication to the second terminal device, an SL beam is indicated in the activation indication, and the activation indication is used for instructing the second terminal device to activate the activated SL beam.

Optionally, in one embodiment of the present disclosure, the apparatus is also configured to:
in response to the activation beam information including an identifier of a second terminal device corresponding to the activated SL beam, send an activation indication to the second terminal device corresponding to the identifier, the activation indication indicating an activated SL beam, and the activation indication is used for instructing the second terminal device to activate the activated SL beam.

Optionally, in one embodiment of the present disclosure, the activation indication indicates the activation of the SL beam by carrying the first indication information corresponding to the activated SL beam.

Optionally, in one embodiment of the present disclosure, the apparatus is also configured to:
communicate with the second terminal device based on the activated SL beam.

FIG. 21 is a schematic diagram of the structure of a communication apparatus provided in the embodiments of the present disclosure, as shown in FIG. 21, the apparatus may include:
a processing module, is configured to determine at least one SL beam configuration applicable to the first terminal device, wherein the first terminal device communicates with the second terminal device based on the SL, and the SL beam configuration includes: first indication information indicating the SL beam, and a reference signal that the SL beam correspondingly carries;
a transceiver module, is configured to receive a reference signal sent by the first terminal device based on the at least one SL beam configuration.

In summary, in the communication apparatus provided in the embodiment of the present disclosure, the first terminal device first determines at least one SL beam configuration, which includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

Optionally, in one embodiment of the present disclosure, the first indication information is the TCI corresponding to the SL beam; and/or
The first indication information is an index identifier corresponding to the SL beam.

Optionally, in one embodiment of the present disclosure, the processing module is further configured to:
Receive at least one SL beam configuration sent by the network device and the identifiers of the first terminal devices to which the at least one SL beam configuration is respectively applicable.

Optionally, in one embodiment of the present disclosure, the processing module is also configured to:
Receive at least one SL beam configuration sent by the first terminal device.

Optionally, in one embodiment of the present disclosure, the apparatus is also configured to:
send capability information to the first terminal device, and the capability information is used for indicating whether the second terminal device supports SL beam capability;

The SL beam capability includes at least one of the following:
SL beam measurement capability;
SL beam measurement reporting capability;
SL beam failure assessment capability;
SL beam failure recovery capability.

Optionally, in one embodiment of the present disclosure, the transceiver module is also configured to:
In response to the capability information indicating the second terminal device supporting the SL beam capability, receives at least one SL beam configuration sent by the first terminal device.

Optionally, in one embodiment of the present disclosure, the apparatus is also configured to:
Measure the reference signal to obtain a reference signal measurement report;
send a reference signal measurement report to the first terminal device.

Optionally, in one embodiment of the present disclosure, the reference signal measurement report includes at least one of the following:
a reference signal measurement result;
a first indication information for indicating the SL beam corresponding to the reference signal measurement result.

Optionally, in one embodiment of the present disclosure, the reference signal measurement result includes at least one of the following:
RSRP;
RSRQ;
SINR.

Optionally, in one embodiment of the present disclosure, the apparatus is also configured to:
receive an activation indication sent by the first terminal device, the activation indication indicates that there is an activated SL beam, and the activation indication is used for instructing the second terminal device to activate the activated SL beam;
determine the activated SL beam based on the activation indication;
communicate with the first communication apparatus based on the activated SL beam.

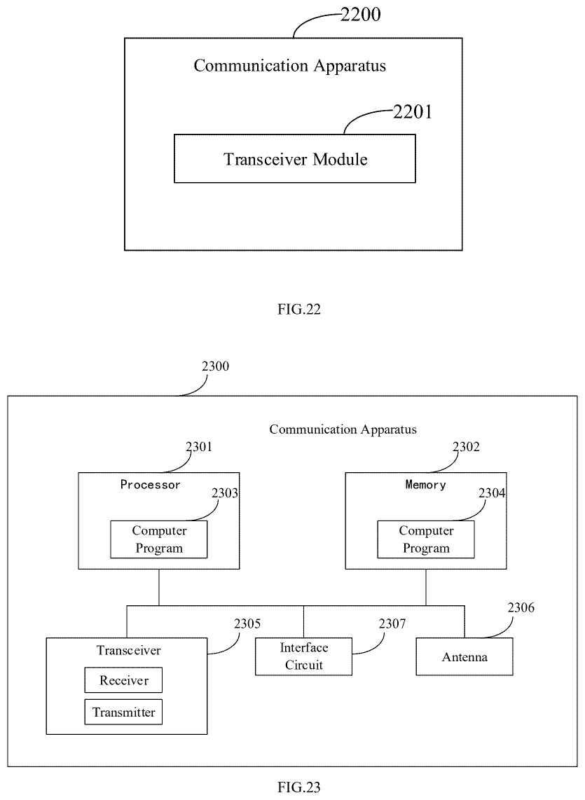

FIG. 22 is a schematic diagram of the structure of a communication apparatus provided in the embodiment of the present disclosure, as shown in FIG. 22, the apparatus may include:
a transceiver module, is configured to indicate at least one SL beam configuration to the first terminal device, and the SL beam configuration includes: first indication information indicating the SL beam, and a reference signal that the SL beam correspondingly carries.

In summary, in the communication apparatus provided in the embodiment of the present disclosure, the first terminal device first determines at least one SL beam configuration, which includes: first indication information indicating the SL beam, and a reference signal corresponding to the SL beam; thereafter, the first terminal device sends the at least one SL beam configuration to the second terminal device, and the first terminal device communicates with the second terminal device based on the SL; In addition, the first terminal device sends a corresponding reference signal to the second terminal device based on the SL beam indicated in at least one SL beam configuration. It can be seen that in the embodiment of the present disclosure, after the SL beam configuration is exchanged between the first terminal device and the second terminal device, the first terminal device will send a corresponding reference signal to the second terminal device based on the SL beam indicated in at least one SL beam configuration, so that the second terminal device can measure the reference signal to obtain a reference signal measurement report and feed it back to the first terminal device, Whereby, the first terminal device can determine which SL beam is to be activated specifically to communicate with the second terminal device based on the reference signal measurement report, the configuration of the SL beam between the first terminal device and the second terminal device is realized, and the embodiment of the disclosure hereby provides a configuration method of the SL beam between the terminal device directly connected by the SL, so that the SL transmission can support beam communication.

Optionally, in one embodiment of the present disclosure, the first indication information is the TCI corresponding to the SL beam; and/or
The first indication information is an index identifier corresponding to the SL beam.

Optionally, in one embodiment of the present disclosure, the apparatus is also configured to:
Receive at least one of the following reported by the first terminal device:
whether the first terminal device supports SL beam capability;
whether the second terminal device supports the SL beam capability, wherein the second terminal device is a terminal device communicating with the first terminal device through SL;
an identifier of the second terminal device;
The SL beam capability includes at least one of the following:
SL beam measurement capability;
SL beam measurement reporting capability;
SL beam failure assessment capability;
SL beam failure recovery capability.

Optionally, in one embodiment of the present disclosure, the transceiver module is also configured to:
in response to the first terminal device and the second terminal device supporting SL beam capability, send a second indication to the first terminal device, the second indication information indicating at least one SL beam configuration; orthe second indication information indicatingt at least one SL beam configuration and the identifier of a second terminal device to which at least one SL beam configuration is respectively applicable.

Optionally, in one embodiment of the present disclosure, the apparatus is also configured to:
Receive at least one of the following reports from the first terminal device:
at least one SL beam configuration supported by the first terminal device;
an index identifier corresponding to at least one SL beam configuration supported by the first terminal device.

Optionally, in one embodiment of the present disclosure, the transceiver module is also configured to:
send a third indication information to the first terminal device, and the third indication information indicates that there is at least one SL beam configuration; or, the third indication indicates that there is at least one SL beam configuration and an identifier of a second terminal device to which at least one SL beam configuration is respectively applicable, wherein the at least one SL beam configuration indicated by the third indication information is any one or more of the SL beam configurations reported by the terminal device.

Optionally, in one embodiment of the present disclosure, the third indication information indicates at least one SL beam configuration by carrying any one or more index identifiers reported by the first terminal device.

Optionally, in one embodiment of the present disclosure, the apparatus is also configured to:
send to the second terminal device at least one SL beam configuration and the identifier of the first terminal device to which the at least one SL beam configuration respectively applicable.

Optionally, in one embodiment of the present disclosure, the apparatus is also configured to:
receive a fourth indication sent by the first terminal device, the fourth indication information includes at least one of the following:
an activated SL beam independently determined by the first terminal device;
a reference signal measurement result corresponding to the activated SL beam;
an identifier of the second terminal device using the activated SL beam.

Optionally, in one embodiment of the present disclosure, the apparatus is also configured to:
receive a fifth indication information sent by the first terminal device, the fifth indication information includes reference signal measurement report and the identifier of the the second terminal device corresponding to the reference signal measurement report.

Optionally, in one embodiment of the present disclosure, the reference signal measurement report includes at least one of the following:
a reference signal measurement result;
a first indication information for indicating the SL beam corresponding to the reference signal measurement result.

Optionally, in one embodiment of the present disclosure, the reference signal measurement result includes at least one of the following:
RSRP;
RSRQ;
SINR.

Optionally, in one embodiment of the present disclosure, the apparatus is also configured to:
determine the activated SL beam between the first terminal device and the second terminal device based on the reference signal measurement report;
send activated beam information to the first terminal device; The activated beam information includes at least one of the following: an active SL beam between the first terminal device and the second terminal device determined by the network device, and an identifier of the second terminal device corresponding to the activated SL beam.

Optionally, in one embodiment of the present disclosure, the apparatus is also configured to:
schedule SL resources for the first terminal device and/or the second terminal device based on the activated SL beam.

Please refer to FIG. 23, which is a schematic diagram of the structure of a communication apparatus 2300 provided in the embodiment of the present application. The communication apparatus 2300 may be a network device, a terminal device, a chip, a chip system, or a processor, etc., that supports the network device to realize the above method, and can also be a chip, a chip system, or a processor, etc., that supports the terminal device to realize the above method. The device can be used to realize the method described in the above method embodiment, and can specifically refer to the description in the above method embodiment.

The communication unit 2300 may include one or more processors 2301. The processor 2301 can be a general-purpose processor or a specialized processor. For example, it can be a baseband processor or a central processing unit. The baseband processor can be used to process the communication protocol and communication data, and the central processing unit can be used to control the communication device (such as base station, baseband chip, terminal device, terminal device chip, DU or CU, etc.), execute computer programs, and process computer program data.

Optionally, the communication apparatus 2300 may also include one or more memory 2302, on which a computer program 2304 may be stored, and the processor 2301 executes the computer program 2304 so that the communication device 2300 performs the method described in the method embodiment. Optionally, data may also be stored in the memory 2302. The communication unit 2300 and memory 2302 can be set up separately or integrated.

Optionally, the communication apparatus 2300 may also include a transceiver 2305 and an antenna 2306. The transceiver 2305 can be called a transceiver unit, a transceiver, or a transceiver circuit, etc., and is used to realize the transceiver function. The transceiver 2305 may include a receiver and a transmitter, and the receiver may be called a receiver or a receiving circuit, etc., and is used to realize the receiving function; The transmitter can be referred to as a transmitter or a transmitting circuit, etc., and is used to implement the transmitting function.

Optionally, one or more interface circuits 2307 may also be included in the communication device 2300. The interface circuit 2307 is used to receive code instructions and transmit them to the processor 2301. The processor 2301 runs the code instruction to cause the communication device 2300 to perform the method described in the above method embodiment.

In one implementation, the processor 2301 may include transceivers for both receive and transmit functions. For example, the transceiver can be a transceiver circuit, or an interface, or an interface circuit. Transceiver circuits, interfaces, or interface circuits used to implement receive and transmit functions can be separate or integrated. The transceiver circuit, interface, or interface circuit may be used for reading and writing code/data, or the transceiver circuit, interface, or interface circuit may be used for the transmission or transmission of signals.

In one embodiment, the processor 2301 may store a computer program 2303, and the computer program 2303 runs on the processor 2301 so that the communication device 2300 can perform the method described in the method in the method embodiment. The computer program 2303 may be solidified in Processor 2301, in which case Processor 2301 may be implemented by hardware.

In one implementation, the communication apparatus 2300 may include a circuit, and the circuit may implement the function of transmitting, receiving, or communicating in the foregoing method embodiments. The processors and transceivers described in this application can be implemented on integrated circuits (IC), analog ICs, radio frequency integrated circuits (RFIC), mixed-signal ICs, application specific integrated circuits (ASIC), printed circuit boards (PCB), electronic devices, and the like. The processors and transceivers can also be manufactured using various IC process technologies, such as complementary metal oxide semiconductor (CMOS), n-type metal oxide semiconductor (NMOS), positive channel metal oxide semiconductor (PMOS), bipolar junction transistor (BJT), bipolar CMOS (BiCMOS), silicon germanium (SiGe), gallium arsenide (GaAs), and so on.

The communication apparatus described in the above embodiment may be a network device or a terminal device, but the scope of the communication device described in the present application is not limited thereto, and the structure of the communication device may not be limited by FIG. 23. The communication device can be a stand-alone device or part of a larger device. For example, the communication device may be:
(1) Stand-alone integrated circuit IC, or chip, or, chip system or subsystem;
(2) a collection with one or more ICs, optionally, the IC collection may also include storage parts for storing data, computer programs;
(3) ASICs, such as modems (Modems);
(4) Modules that can be embedded in other devices;
(5) Receivers, terminal device, intelligent terminal device, cellular phones, wireless devices, handsets, mobile units, vehicle equipment, network device, cloud equipment, artificial intelligence equipment, etc. ;
(6) Others, Etc.

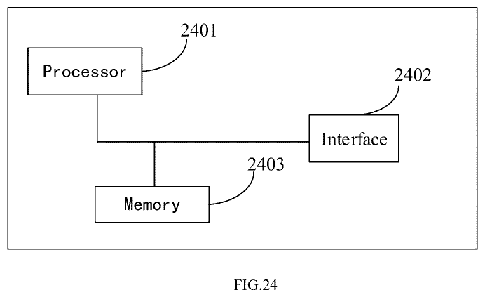

For cases where the communication apparatus can be a chip or a system-on-a-chip, see the schematic diagram of the chip structure shown in FIG. 24. The chip shown in FIG. 24 includes a processor 2401 and an interface 2402. The number of processor 2401 can be one or more, and the number of interface 2402 can be multiple.

Optionally, the chip also includes memory 2403, which is used to store the necessary computer programs and data.

Those skilled in the art may also understand that the various illustrative logical blocks and steps listed in the embodiments of the present application may be realized by electronic hardware, computer software, or a combination of both. Whether this is achieved in hardware or software depends on the specific application and the design requirements of the system as a whole. A person skilled in the art may use various methods to implement the described function for each particular application, but such implementation shall not be construed as going beyond the scope of protection of the embodiments of the present application.

The application also provides a readable storage medium on which instructions are stored to realize the functions of any of the above method embodiments when executed by a computer.

The application also provides a computer program product that, when executed by a computer, realizes the functions of any of the above method embodiments.

In the above embodiment, it may be realized in whole or in part by software, hardware, firmware, or any combination thereof. When implemented using software, it can be implemented in whole or in part in the form of a computer program product. The computer program product includes one or more computer programs. When the computer program is loaded and executed on a computer, a process or function described in the embodiments of the present application is produced, in whole or in part. The computer may be a general-purpose computer, a special-purpose computer, a computer network, or other programmable device. The computer program may be stored in a computer-readable storage medium, or transmitted from one computer-readable storage medium to another computer-readable storage medium, for example, the computer program may be sent to another website site, computer, or data center by wired (e.g., coaxial cable, optical fiber, digital subscriber line, DSL)) or wireless (e.g., infrared, wireless, microwave, etc.) to another website site, computer, server or data center for transmission. The computer-readable storage medium may be any usable medium that the computer can access or a data storage device such as a server, a data center, etc., which is integrated with one or more usable media. The available medium may be a magnetic medium (e.g., floppy disk, hard disk, magnetic tape), optical medium (e.g., high-density digital video disc (DVD)), or semiconductor medium (e.g., solid state disk (SSD)).

A person skilled in the art may understand that the first and second numerical numbers involved in the present application are only for the convenience of description, and are not used to limit the scope of the embodiments of the present application, and also indicate the order.

At least one of the present application may also be described as one or more, and plurality may be two, three, four, or more, without limitation in the present application. In the embodiment of the present application, for a technical feature, the technical features in the technical features are distinguished by “first”, “second”, “third”, “A”, “B”, “C” and “D”, etc., and the technical features described by “first”, “second”, “third”, “A”, “B”, “C” and “D” are not in order or in order of magnitude.

The correspondence shown in the tables in this application can be configured or predefined. The values of the information in each table are only examples and can be configured to other values, and are not limited to this application. When configuring the correspondence between information and parameters, it is not necessary to conFig. all the correspondences shown in each table. For example, in the table in this application, the correspondence shown in some rows can also be left unconfigured. For example, you can make appropriate deformation adjustments based on the above table, such as splitting, merging, etc. The names of the parameters indicated in the headings of the tables above may also be other names that are understandable to the communication device, and the values or representations of the parameters may also be other values or representations that are understandable to the communication device. Other data structures can also be used in the implementation of each of the above tables, such as arrays, queues, containers, stacks, linear tables, pointers, linked lists, trees, graphs, structs, classes, heaps, hash tables, or hash tables.

The predefinition in this application can be understood as defining, predefining, storing, pre-storing, pre-negotiating, pre-configuring, curing, or pre-firing.

Those skilled in the art may realize that the units and algorithm steps of each example described in combination with the embodiments disclosed herein can be realized by electronic hardware, or a combination of computer software and electronic hardware. Whether these functions are performed in hardware or software depends on the specific application and design constraints of the technical solution. A skilled person may use different methods to achieve the described function for each particular application, but such implementation shall not be considered outside the scope of the present application.

Those skilled in the art can clearly understand that, for the convenience and conciseness of the description, the specific working process of the system, device and unit described above can refer to the corresponding process in the aforesaid method embodiment, and will not be repeated herein.

The foregoing is only the specific embodiment of the present application, but the scope of protection of the present application is not limited to this, and any person skilled in the art who is familiar with the art can easily think of changes or substitutions within the scope of the technology disclosed in this application, shall be covered by the scope of protection of this application. Therefore, the scope of protection of the present application shall be subject to the scope of protection of the said claim.

1. A sidelink (SL) beam configuration method, comprising:
determining, by a first terminal device, at least one SL beam configuration, wherein the SL beam configuration comprises: first indication information indicating an SL beam, and a reference signal corresponding to the SL beam;
sending, by the first terminal device, the at least one SL beam configuration to a second terminal device, wherein the first terminal device communicates with the second terminal device based on the SL beam; and
sending, by the first terminal device, a reference signal to the second terminal device based on the SL beam indicated in the at least one SL beam configuration.

2. The method of claim 1, wherein the first indication information is a transmission configuration indication transmission configuration indicator (TCI) corresponding to the SL beam; or
the first indication information is an index identifier corresponding to the SL beam.

3. The method of claim 1, wherein in response to the first terminal device being in a connected state, or, the first terminal device allocating SL sending resources based on dynamic scheduling of a network device, determining the at least one SL beam configuration, comprises one of following:
determining the at least one SL beam configuration based on an indication of the network device; or
determining the at least one SL beam configuration and an identifier of the second terminal device to which the at least one SL beam configuration is respectively applicable based on an indication of the network device.

4. The method of claim 3, further comprising:
reporting at least one of followings to the network device:
whether the first terminal device supporting SL beam capability;
whether the second terminal device supporting SL beam capability; or
the identifier of the second terminal device;
wherein the SL beam capability comprising at least one of followings:
SL beam measurement capability;
SL beam measurement reporting capability;
SL beam failure assessment capability; or
SL beam failure recovery capability.

5. The method of claim 4, wherein determining the at least one SL beam configuration based on the indication of the network device, or determining the at least one SL beam configuration and the identifier of the second terminal device to which the at least one SL beam configuration is respectively applicable based on an indication of the network device, comprises:
in response to both the first terminal device and the second terminal device supporting the SL beam capability, receiving a second indication information sent by the network device, and the second indication information indicating the at least one SL beam configuration; or, the second indication information indicating the at least one SL beam configuration and the identifier of the second terminal device to which the at least one SL beam configuration is respectively applicable; and
determining the at least one SL beam configuration indicated by the network device based on the second indication information, or determining the at least one SL beam configuration and the identifier of the second terminal device to which the at least one SL beam configuration is respectively applicable.

6. The method of claim 3, further comprising:
in response to determining that the network device supports the configuration of the SL beam configuration, reporting at least one of followings to the network device:
at least one SL beam configuration supported by the first terminal device; or
an index identifier corresponding to the at least one SL beam configuration supported by the first terminal device;
wherein determining the at least one SL beam configuration based on the indication of the network device, or determining the at least one SL beam configuration and an identifier of the second terminal device to which the at least one SL beam configuration is respectively applicable, comprises:
receiving a third indication information sent by the network device, and the third indication information indicating the at least one SL beam configuration; or, the third indication information indicating the at least one SL beam configuration and the identifier of the second terminal device to which the at least one SL beam configuration is respectively applicable, wherein the at least one SL beam configuration indicated by the third indication information is any one or more of the SL beam configurations reported by the terminal device; and
determining the at least one SL beam configuration indicated by the network device based on the third indication information, or determining the identifier of the second terminal device to which the at least one SL beam configuration is respectively applicable;
wherein the third indication information indicates the at least one SL beam configuration by carrying any one or any plurality of index identifiers reported by the first terminal device.

7-8. (canceled)

9. The method of claim 3, wherein in response to determining that the network device does not indicate the identifier of the second terminal device, the SL beam configuration indicated by the network device is applicable to all second terminal devices connected with the first terminal device through SL;
or
wherein sending the at least one SL beam configuration to the second terminal device, comprises:
in response to the network device indicating an identifier of the second terminal device, sending a corresponding SL beam configuration to the second terminal device based on the identifier of the second terminal device.

10. (canceled)

11. The method of claim 1, further comprising:
receiving, by the first terminal device, capability information sent by the second terminal device, wherein the capability information is configured for indicating whether the second terminal device supports SL beam capability;
wherein the SL beam capability comprising at least one of followings:
SL beam measurement capability;
SL beam measurement reporting capability;
SL beam failure assessment capability; or
SL beam failure recovery capability;
wherein sending the SL beam configuration to the second terminal device, comprises:
in response to the capability information indicating that the second terminal device supports the SL beam capability, sending the SL beam configuration to the second terminal device.

12. (canceled)

13. The method of claim 1, further comprising:
receiving, by the first terminal device, a reference signal measurement report sent by the second terminal device;
determining, by the first terminal device, an activated SL beam between the first terminal device and the second terminal device based on the reference signal measurement report;
communicating, by the first terminal device, with the second terminal device based on the activated SL beam;
wherein the reference signal measurement report comprises at least one of followings:
a reference signal measurement result; or
a first indication information for indicating the SL beam corresponding to the reference signal measurement report.

14. (canceled)

15. The method of claim 13,
wherein determining the activated SL beam between the first terminal device and the second terminal device based on the reference signal measurement report, comprises:
independently determining, by the first terminal device, the activated SL beam between the first terminal device and the second terminal device based on the reference signal measurement result in the reference signal measurement report;
wherein the method further comprises:
sending a fourth indication information to the network device, wherein the fourth indication information comprising at least one of followings:
an activated SL beam independently determined by the first terminal device;
a reference signal measurement result corresponding to the activated SL beam; or
an identifier of the second terminal device using the activated SL beam;
wherein sending the fourth indication information to the network device, comprises:
in response to determining that the network device supports the configuration of the SL beam configuration, sending the fourth indication information to the network device.

16. (canceled)

17. The method of claim 13, further comprising:
sending a fifth indication information to the network device, wherein the fifth indication information comprises the reference signal measurement report and an identifier of the second terminal device corresponding to the reference signal measurement report;
wherein determining the activated SL beam between the first terminal device and the second terminal device based on the reference signal measurement report, comprises:
receiving activated beam information sent by the network device, wherein the activated beam information comprises at least one of followings: an activated SL beam between the first terminal device and the second terminal device determined by the network device, and an identifier of the second terminal device corresponding to the activated SL beam; and
determining the activated SL beam based on the activated beam information;
wherein sending the fifth indication information to the network device, comprises:
in response to determining that the network device supports the SL beam configuration, sending the fifth indication information to the network device.

18-19. (canceled)

20. The method of claim 6, wherein determining the network device supports the SL beam configuration, comprises:
in response to determining at least one of followings: the network device has configured an SL beam configuration to the first terminal device through system information or radio resource control RRC reconfiguration messages, determining that the network device supports the SL beam configuration.

21. The method of claim 15, further comprising:
sending an activation indication to the second terminal device, wherein the activation indication indicates the activated SL beam, and the activation indication is configured for indicating the second terminal device to activate the activated SL beam;
wherein the activation indication indicates the activated SL beam by carrying a first indication information corresponding to the activated SL beam;
in response to the activation beam information comprising the identifier of the second terminal device corresponding to the activated SL beam, sending an activation indication to the second terminal device corresponding to the identifier, wherein the activation indication indicates an activated SL beam, and the activation indication is configured for indicating the second terminal device to activate the activated SL beam.

22-24. (canceled)

25. An SL beam configuration method, comprising:
determining, by a second terminal device, at least one SL beam configuration applicable to a first terminal device, wherein the first terminal device communicates with the second terminal device based on the SL, and the SL beam configuration comprises: first indication information indicating the SL beam, and a reference signal correspondingly carried by the SL beam; and
receiving, by the second terminal device, a reference signal transmitted by the first terminal device based on the at least one SL beam configuration.

26-31. (canceled)

32. An SL beam configuration method, comprising:
indicating, by a network device, at least one SL beam configuration to a first terminal device, wherein the SL beam configuration comprises: first indication information indicating an SL beam, and a reference signal carried by the SL beam.

33-37. (canceled)

38. The method of claim 32, further comprising:
sending the at least one SL beam configuration and an identifier of the first terminal device to which the at least one SL beam configuration is respectively applicable, to the second terminal device.

39-45. (canceled)

46. A communication apparatus, comprising:
a processor and
a memory, wherein a computer program is stored in the memory, and the processor executes the computer program stored in the memory so that the device performs the method according to claim 1.

47. A non-statutory computer-readable storage medium for storing instructions, when the instructions are executed, cause the method according to claim 1 to be implemented.

48. A communication apparatus, comprising:
a processor and
a memory, wherein a computer program is stored in the memory, and the processor executes the computer program stored in the memory so that the device performs the method according to claim 32.

49. A non-statutory computer-readable storage medium for storing instructions, when the instructions are executed, cause the method according to claim 32 to be implemented.
